(19) United States
(12) Patent Application Publication
(10) Pub. No.: US 2026/0276094 A1
(43) Pub. Date: Sep. 17, 2026

(54) AUXILIARY HYDRAULIC PORT EXPANSION SYSTEM FOR EXCAVATORS

(71) Applicant: Ahearn Equipment, Inc., Spencer, MA (US)

(72) Inventor: Joshua Ahearn, Spencer, MA (US)

(73) Assignee: Ahearn Equipment, Inc., Spencer, MA (US)

(21) Appl. No.: 19/563,895

(22) Filed: Mar. 11, 2026

Related U.S. Application Data
(60) Provisional application No. 63/773,213, filed on Mar. 17, 2025.

(51) Int. Cl. F16K 11/072; F15B 13/04; F16K 31/60; E02F 9/22

(52) U.S. Cl. CPC F16K 11/072; F15B 13/0401; F16K 31/602; E02F 9/2225; E02F 9/2267; E02F 9/2275

(57) ABSTRACT

A diverter valve assembly for a hydraulic system is disclosed that includes a diverter valve that couples a first fluid port to either a second fluid port or a third fluid port depending on a position of the diverter valve. The diverter valve assembly further includes an attachment system for attaching the diverter valve to a machine. The attachment system includes an adapter plate configured to attach to pre-existing mounting holes on a structural member of the machine including a stick without drilling or welding. The diverter valve is mechanically secured to the adapter plate.

### CROSS REFERENCE TO RELATED APPLICATIONS

This application claims priority to U.S. Provisional Application No. 63/773,213, filed Mar. 17, 2025, the entirety of which is incorporated herein by reference pursuant to 35 U.S.C. §119(e).

### TECHNICAL FIELD

The present disclosure relates generally to adapting a function of an excavator and specifically to expanding the auxiliary hydraulic capabilities of an excavator.

### BACKGROUND

Most excavators are designed to include only two auxiliary hydraulic circuits, limiting their ability to accommodate attachments requiring multiple hydraulic functions. Further, integrating machines with attachments can be difficult due to the lack of standardization within the construction equipment industry, making it challenging for machine owners to upgrade their equipment efficiently. Still further, many new and innovative hydraulic powered tools and attachments have been introduced into the marketplace in the past 10 years.

A hydraulic port system provides a simple solution to adapt machines to new hydraulic powered tools and attachments. The system incorporates a series of brackets and hydraulic diverter valves, enabling an excavator to effectively operate three auxiliary ports using two existing circuits. The system can be adapted to a wide range of excavator models by simply modifying the configuration of one or two of the existing brackets. This allows owners to upgrade their equipment and quickly attach complex hydraulic-powered tools or attachments, enhancing the versatility and functionality of their excavators. In some aspects, the techniques described herein relate to a diverter valve assembly for a hydraulic system including: a diverter valve that couples a first fluid port to either a second fluid port or a third fluid port depending on a position of a lever; and an attachment system for attaching the diverter valve to a machine; wherein the attachment system includes an adapter plate designed for attachment to a model of the machine.

Herein disclosed, is a diverter valve assembly for a hydraulic system that includes a diverter valve that couples a first fluid port to either a second fluid port or a third fluid port depending on a position of the diverter valve, and an attachment system for attaching the diverter valve to a machine. The attachment system includes an adapter plate configured to attach to pre-existing mounting holes on a structural member of the machine including a stick without drilling or welding, wherein the diverter valve is mechanically secured to the adapter plate.

In some examples, the adapter plate may include a first set of holes aligned with corresponding holes in the diverter valve for attaching the diverter valve to the adapter plate, and a second set of holes aligned with corresponding holes on the machine for attaching the adapter plate to the machine.

In some examples, the attachment system may further include a spacer bar, wherein the spacer bar is mountable between the diverter valve and the adapter plate such that when assembled a cavity is formed between the diverter valve and the adapter plate while the diverter valve remains in contact with the adapter plate at one or more locations.

In some examples, the spacer bar may form holes that are aligned with the holes on the diverter valve and further aligned with the first set of holes on the adapter plate such that the diverter valve, the spacer bar, and the adapter plate are mechanically attachable using a plurality of bolts.

In some examples, the diverter valve assembly may further include a hydraulic hose selected from a plurality of hydraulic hoses, wherein the plurality of hydraulic hoses includes at least a first hose having a first length corresponding to a first machine model and a second hose having a second length corresponding to a second machine model.

In some examples, the diverter valve assembly may further include a bulkhead adapter configured to connect a first end of one of the plurality of hydraulic hoses to an existing auxiliary hydraulic circuit of the machine, wherein the bulkhead adapter is configured to interface with a pre-existing auxiliary hydraulic pipe of the machine without permanently modifying a hydraulic circuit.

In some examples, the diverter valve assembly may further include a quick coupler for connecting an attachment to at least one of the second fluid port or the third fluid port of the diverter valve.

In some examples, the diverter valve assembly may be configured for retrofit installation on an existing machine, wherein installation of the diverter valve assembly preserves operability of an original auxiliary hydraulic port and enables creation of an additional auxiliary hydraulic port.

In some examples, the adapter plate may utilize original equipment manufacturer mounting holes.

In some examples, the diverter valve may be actuatable by a manually actuated mechanism including at least one of a lever, a knob, a nut, or a tool-engageable drive member, by an electrical actuator, or by an electro-hydraulic actuator.

In some examples, the diverter valve assembly may be provided as part of a retrofit kit including a first diverter valve assembly fluidly connected to a pressure side of an auxiliary hydraulic circuit of the machine and a second diverter valve assembly fluidly connected to a return side of the auxiliary hydraulic circuit of the machine, wherein selective actuation of the first diverter valve assembly and the second diverter valve assembly enables selective routing of hydraulic flow to three auxiliary hydraulic ports from two original auxiliary hydraulic circuits.

In some examples, the diverter valve assembly may further include a stand-off plate positioned between the adapter plate and the structural member of the machine, the stand-off plate creating a clearance gap between the adapter plate and the structural member, the clearance gap accommodating protruding fastening elements extending from the adapter plate toward the structural member.

Herein disclosed is a retrofit kit for expanding auxiliary hydraulic functionality of a machine including a diverter valve having a first fluid port selectively connectable to either a second fluid port or a third fluid port based on a position of the diverter valve, an adapter plate configured to attach the diverter valve to pre-existing mounting holes on a structural member of the machine without drilling or welding, at least one spacer bar configured to mount between the diverter valve and the adapter plate, a bulkhead adapter configured to fluidly interface with an auxiliary hydraulic circuit of the machine, and a plurality of hydraulic hoses having different lengths corresponding to different machine mounting geometries.

In some examples, the retrofit kit may further include a second adapter plate configured for a second machine having a different mounting hole pattern.

In some examples, the adapter plate may include multiple sets of mounting holes corresponding to different machine models.

In some examples, the plurality of hydraulic hoses and the adapter plate may be selected to enable installation on more than one machine model using only original equipment manufacturer mounting holes.

Herein disclosed is a method of expanding auxiliary hydraulic functionality of a machine that includes mounting a diverter valve to a structural member of the machine using an adapter plate attached to pre-existing mounting holes on the structural member without drilling or welding, fluidly coupling the diverter valve to an existing auxiliary hydraulic circuit of the machine, and actuating the diverter valve to selectively route hydraulic flow from a first fluid port to either a second fluid port or a third fluid port.

In some examples, the method may further include selecting at least one of a plurality of adapter plates having a mounting hole pattern corresponding to a machine model and selecting a hydraulic hose having a length corresponding to a mounting geometry of the machine model based on dimensional information associated with the machine model.

In some examples, fluidly coupling the diverter valve to the existing auxiliary hydraulic circuit may be performed without permanently modifying the existing auxiliary hydraulic circuit of the machine.

In some examples, the method may further include mounting a second diverter valve to the structural member of the machine, fluidly connecting a first diverter valve to a pressure side of the existing auxiliary hydraulic circuit and fluidly connecting the second diverter valve to a return side of the existing auxiliary hydraulic circuit, and selectively actuating the first diverter valve and the second diverter valve to provide three selectively operable auxiliary hydraulic ports from two original auxiliary hydraulic circuits.

### BRIEF DESCRIPTION OF THE DRAWINGS

The foregoing and other features and advantages of the present disclosure will become apparent to those skilled in the art to which the present disclosure relates upon reading the following description with reference to the accompanying drawings, in which:

FIG. 1 illustrates an example excavator stick including one side of a hydraulic system including two auxiliary ports;

FIG. 2 illustrates an example excavator stick with a hydraulic system that has been adapted from two auxiliary ports to three auxiliary ports;

FIG. 3 illustrates a side view of an example diverter valve assembly for converting one side of a hydraulic system from two auxiliary ports to three auxiliary ports;

FIG. 4 illustrates a front view of an example diverter valve assembly for converting the one side of the hydraulic system from two auxiliary ports to three auxiliary ports;

FIG. 5 illustrates a first perspective view of an example diverter valve assembly for converting the one side of the hydraulic system from two auxiliary ports to three auxiliary ports;

FIG. 6 illustrates a second perspective view of an example diverter valve assembly for converting the one side of the hydraulic system from two auxiliary ports to three auxiliary ports;

FIG. 7 illustrates an example diverter valve;

FIG. 8 illustrates an example spacer bar;

FIG. 9 illustrates an example adapter plate;

FIG. 10 illustrates installation of hydraulic fittings including quick couplers and sliding collars on diverter valves;

FIG. 11 illustrates mounting of a spacer bar to the diverter valve;

FIG. 12 illustrates an adapter plate attached to an excavator stick;

FIG. 13 is a diagram showing cavity and clearance of an installed diverter valve assembly;

FIG. 14 illustrates a side view of installed diverter valve assembly;

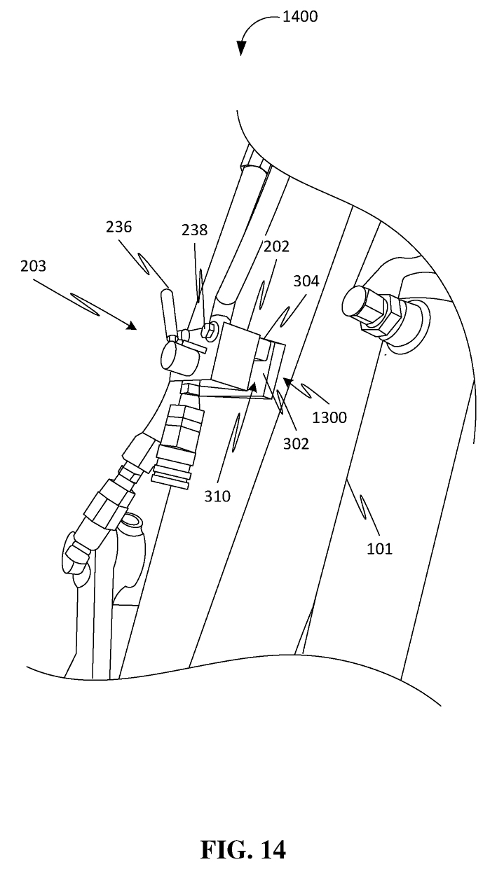

FIG. 15 illustrates a return side installation of the diverter valve assembly; and

FIG. 16 is a flowchart showing a process of installation of an exemplary diverter valve assembly.

### DETAILED DESCRIPTION

Referring now to the discussion that follows, and to the drawings, illustrative approaches to the disclosed systems and methods are shown in detail. Although the drawings represent some possible approaches, the drawings are not necessarily to scale and certain features may be exaggerated, removed, or partially sectioned to better illustrate and explain the present disclosure. Further, the descriptions set forth herein are not intended to be exhaustive or otherwise limit or restrict the claims to the precise forms and configurations shown in the drawings and disclosed in the following detailed description.

A hydraulic system for an excavator or other similar machine includes a pressure side that delivers hydraulic fluid under pressure from a hydraulic pressure source to the attachments that it operates, and a return side that allows the hydraulic fluid to return to the hydraulic pressure source. As the pressure side and return side are typically the same or nearly the same, this paper will describe the pressure side in detail below, with the understanding that the second, return side has same or similar features.

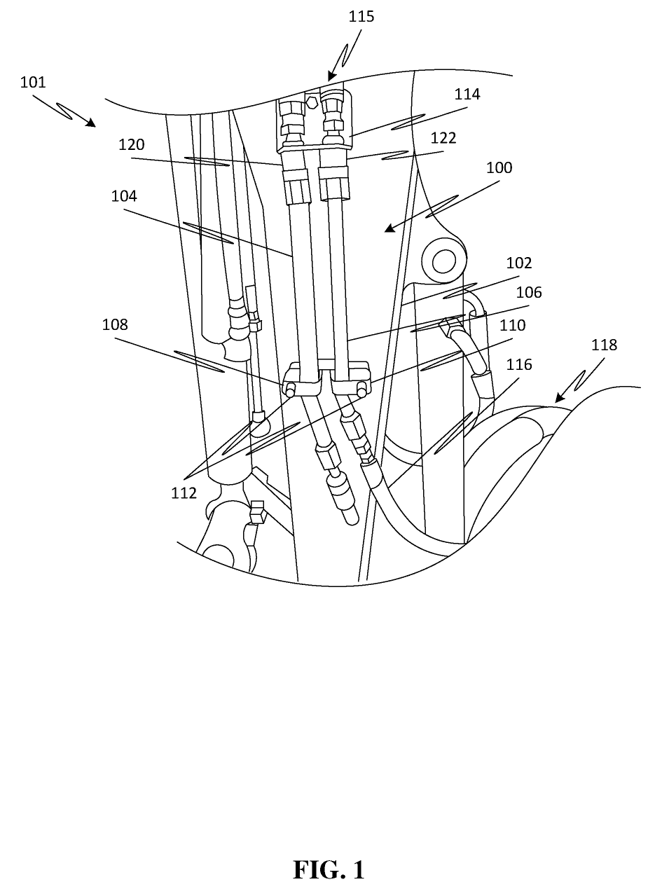

FIG. 1 illustrates an example hydraulic plumbing 100 for a pressure side of a hydraulic system supporting two auxiliary ports. The example hydraulic plumbing 100 is mounted on an excavator stick 102 of a machine 101, e.g., an excavator, manufactured by an Original Equipment Manufacturer (OEM). The example plumbing includes a first pipe 104 for a first auxiliary hydraulic port and a second pipe 106 for a second auxiliary port. In an example excavator machine, the first pipe 104 may be used for hydraulic control of a shovel or other larger attachment to the excavator. The second pipe 106 may be smaller (narrower diameter) than the first pipe 104 and may be used to control, for example, a thumb of the excavator.

The first and second pipes 104, 106 are mechanically attached to the stick 102 via clamps 108, 110 using bolts 112 mechanically coupled to mounting holes (not shown). Each of the first and second pipes 104, 106 are attached on a first side to a connector 114 which connects the first and second pipes 104, 106 to a hydraulic pressure side 115. The clamps 108, 110 are manufactured and installed by OEM as a part of manufacturing the machine 101. A clamp 108, 110 is typically formed of metal shaped to hold the pipes 104, 106 attached to the machine 101.

With reference to example shown in FIG. 1, the second pipe 106 is connected, via appropriate adapters, via a thumb hose 116 to a thumb of the excavator machine 101. As used herein, the term “thumb” refers to an attachment hydraulic accessory configured to cooperate with a bucket or other implement of a machine to grasp, clamp, or secure objects therebetween. The thumb is typically pivotally mounted to a stick, arm, or boom of the machine and is movable between a retracted position, in which the thumb does not interfere with normal bucket operation, and a grasping position, in which the thumb is positioned toward the bucket to clamp an object between the thumb and the bucket.

A similar hydraulic plumbing arrangement is provided on return side to complete hydraulic plumbing 100 and to service the example thumb 118. The thumb 118 is fluidly coupled to hydraulic plumbing 100 through auxiliary hydraulic pipe 116. Pressurized fluid supplied to the thumb 118 moves the thumb 118 toward a grasping position while fluid from an opposite side returns through the return side to a reservoir (not shown). Reversing the flow retracts the thumb 118.

In various operating configurations, hydraulic machinery such as a machine 101 (for example, an excavator) may be equipped with one or more auxiliary hydraulic circuits configured to power hydraulic attachments. In some configurations, a hydraulic attachment may remain fluidly connected to one of the auxiliary hydraulic circuits during normal operation of the machine 101. For example, the machine 101 may include a hydraulic thumb 118 that remains connected to one of the auxiliary hydraulic circuits while operating together with a bucket or another primary tool of the machine 101.

Hydraulic attachments have been developed that include multiple hydraulic functions and may operate more effectively when supplied by two auxiliary hydraulic circuits. In some operating situations, an operator may wish to operate such a multi-function hydraulic attachment on a machine 101 that already has another hydraulic attachment connected to one of the auxiliary hydraulic circuits.

In these situations, the hydraulic attachment connected to the auxiliary circuit may conventionally be disconnected from the circuit in order to free the circuit for use by the other attachment. Disconnecting hydraulic lines may result in loss of hydraulic fluid and removal of hydraulic pressure that otherwise maintains the attachment in position. As a result, the attachment may need to be mechanically secured, for example by strapping or chaining, or removed from the machine 101. These procedures may introduce inefficiencies during attachment changes and may also create undesirable fluid leakage or safety concerns.

Accordingly, there exists a need for a retrofit system capable of converting a machine 101, e.g., an excavator, having two auxiliary circuits into a machine 101 capable of selectively operating three auxiliary ports while preserving existing hydraulic supply interfaces and mounting locations on, e.g., the excavator stick.

The hydraulic configurations described herein address these situations by providing a diverter arrangement that allows a hydraulic attachment, such as a thumb 118, to remain fluidly connected and pressurized while hydraulic flow may be selectively routed to an additional auxiliary hydraulic port. In this manner, multi-function hydraulic attachments may be operated using the existing auxiliary hydraulic circuits of the machine 101 without requiring permanent modification of the machine or disconnection of the existing hydraulic attachment.

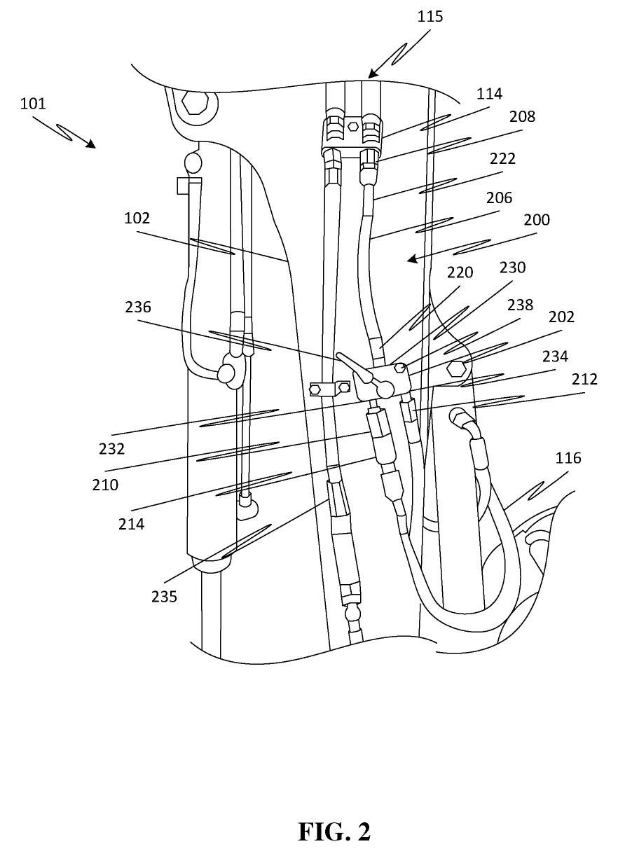

FIG. 2 illustrates a diverter valve assembly 200 after the hydraulic plumbing 100 originally manufactured by the OEM of the machine 101 has been modified to install an aftermarket diverter valve assembly 200.

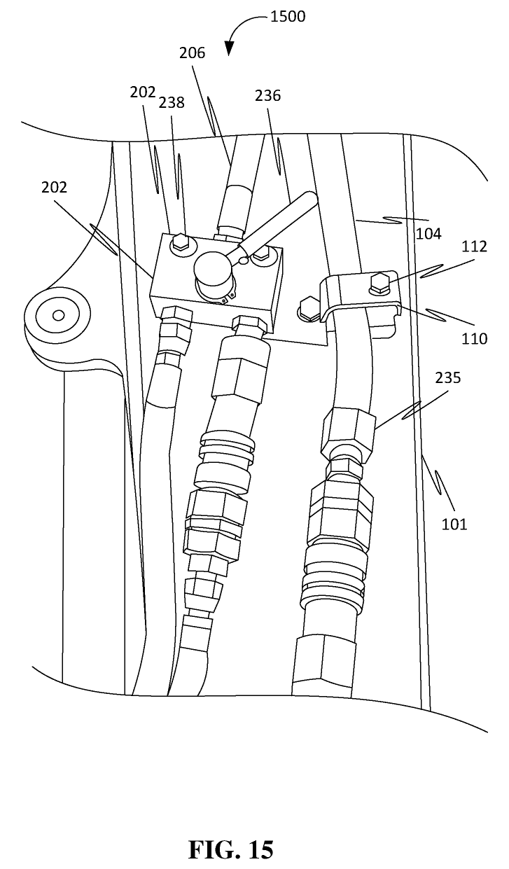

The diverter valve assembly 200 is provided as part of a retrofit kit for expanding auxiliary hydraulic functionality including a first diverter valve assembly 200 fluidly connected to a pressure side 115 of an auxiliary hydraulic circuit of the machine 101, and a second diverter valve assembly 200 fluidly connected to a return side 1500 of the auxiliary hydraulic circuit of the machine 101 (See FIG. 15). In this context, expanding auxiliary hydraulic functionality means providing a possibility of an additional hydraulic connection of a hydraulic accessory to a machine 101. The retrofit kit may include installation instructions directing the user to determine mounting geometry and hydraulic routing dimensions of a specific machine model prior to selecting components of the kit.

The diverter valve assembly 200 is configured for retrofit installation on an existing machine 101. With respect to FIG. 2-6, the diverter valve assembly 200 can include a diverter valve 202, a hydraulic hose 206, an NPT bulkhead adapter 208, a flat-faced quick coupler 210, a JIC hose end fitting 212 and a sliding collar 214 adapter. The diverter valve assembly 200 further includes an adapter plate 302, and a spacer bar 304. The adapter plate 302 and the spacer bar 304 can be used to attach the diverter valve 202 to the stick 102 of the excavator machine 101.

A pressure side 115 of a hydraulic plumbing 100 is adapted to supporting three auxiliary hydraulic ports 232, 234, 235 from two original auxiliary hydraulic circuits 120, 122. The installation of the diverter valve assembly 200 preserves operability of an original auxiliary hydraulic port 235, and the diverter valve assembly 200 enables creation of an additional auxiliary hydraulic port. In the illustrated example, the port 235 is a pre-existing port provided based on the OEM configuration, and the ports 232, 234 are provided upon installation of the diverter valve assembly 200.

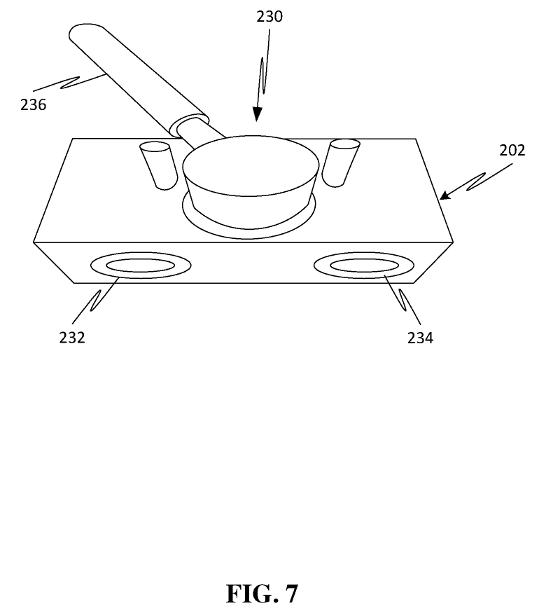

With respect to FIGS. 2-4, the diverter valve 202 is a hydraulic valve having three ports 230, 232, 234. The diverter valve 202 fluidly couples the first fluid port 230 to either a second fluid port 232 or a third fluid port 234 depending on a position of the diverter valve 202. Selective actuation of the first diverter valve assembly 200 and the second diverter valve assembly 200 enables selective routing of hydraulic flow to one of the ports 232, 234. The diverter valve 202 may be actuatable by (a) a manually actuated mechanism including at least one of a lever (FIG. 7) , a knob, a nut, or a tool-engageable drive member. In an example, by changing a position of a lever 236, the diverter valve 202 selects either the first flow circuit from the first port 230 to the second port 232, or the second flow circuit from the first port 230 to the third port 234.

Alternatively, the diverter valve 202 may be actuated electrically or electro-hydraulically. In an example employing electrical or electro-hydraulic actuation, the diverter valve 202 may include or be operatively coupled to an electrical actuator (e.g., a solenoid), motor-driven actuator, pilot valve, or similar electrically responsive device configured to shift the valve between flow positions upon receipt of an electrical control signal. The control signal may be generated by an operator-actuated switch, button, rocker, joystick input, or other control interface located within the operator cabin and/or at an external control station of the machine 101. In an electro-hydraulic configuration, the electrical signal actuates a pilot stage that hydraulically shifts a main spool of the diverter valve 202. Electrical power may be supplied by the machine’s electrical system, and wiring may be routed along the boom, stick, or frame in conjunction with the hydraulic pipes.

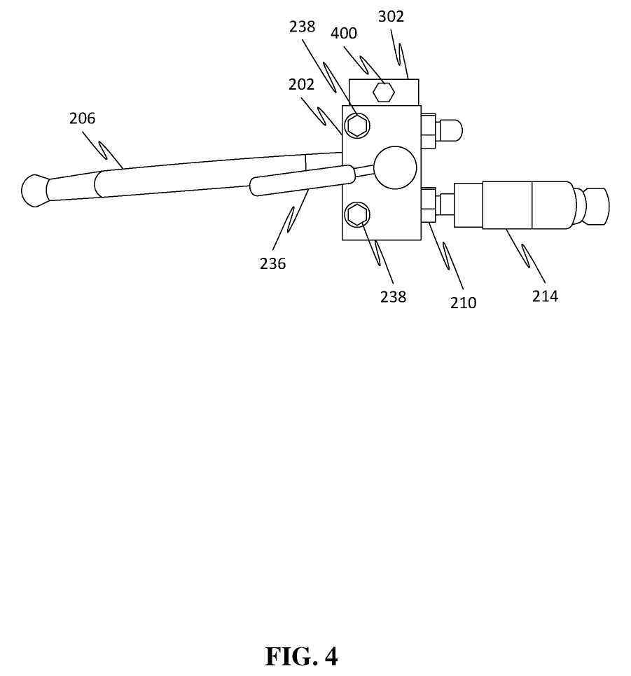

FIGS. 4, 5 and 6 respectively show a front view, a first perspective view, and a second perspective view of the diverter valve assembly 200. The bolts 238 are mounted via holes (not shown) in the diverter valve 202, to facilitate attaching the diverter valve 202 to the spacer bar 304 and the adapter plate 302.

With continued reference to FIGS. 2-7, reconfiguration of hydraulic plumbing to install the retrofit kit including the diverter valve assembly 200 is disclosed. Reconfiguration of the hydraulic plumbing of a machine 101 to install the diverter valve assembly 200 includes fluidly coupling the diverter valve 202 to the existing hydraulic circuits without permanently modifying the existing auxiliary hydraulic circuit of the machine 101. One of the OEM hydraulic circuits 120, 122 is reversibly modified to install the diverter valve assembly 200.

Reversible, in the context of the present disclosure, means that installation of the retrofit kit does not require cutting, drilling, boring, or otherwise permanently modifying any OEM component. As a result, the hydraulic plumbing system 100 of the machine 101 can be restored to its original OEM configuration using the same OEM parts—such as rigid pipe 106—without requiring replacement or procurement of new OEM components.

The NPT bulkhead adapter 208 is configured to interface with a pre-existing auxiliary hydraulic pipe 104, 106 of the machine 101 without permanently modifying the hydraulic circuits 120, 122. Upon removing one of the auxiliary pipes 104, 106 from one of the hydraulic circuits 120, 122, a bulkhead adapter 208 is used to connect a first end of one of the plurality of hydraulic hoses 206 to an existing auxiliary hydraulic circuit 120, 122 of the machine 101. In the example of FIG. 2, the hose 206 is connected via the connector 114 to the hydraulic circuit 122.

The NPT bulkhead adapter 208 is provided with a BPS O-ring side for connecting to the connector 114 and a JIC cone side for connecting to the second end 222 of the hydraulic hose 206. The hydraulic hose 206 is flexible and configured to be installed between the diverter valve 202 and the connector 114 to the hydraulic pressure source. A first end of hydraulic hose 206 is connected to first port 230 of diverter valve 202. A second end of hydraulic hose 206 is connected to bulkhead adapter 208. In the example shown in FIG. 2, the hydraulic hose 206 establishes fluid communication between the hydraulic circuit 122 and the diverter valve 202.

In an example, a first end 220 of the hydraulic hose 206 can be a fitted with an SAE O-ring and can be connectable to the first port 230 of the diverter valve. A second end 222 of the hydraulic hose 206 can be fitted with a JIC for connecting to the connector 114 via the NPT bulkhead adapter 208. Connections may be additionally sealed with sealing compounds such as Blue Loctite.

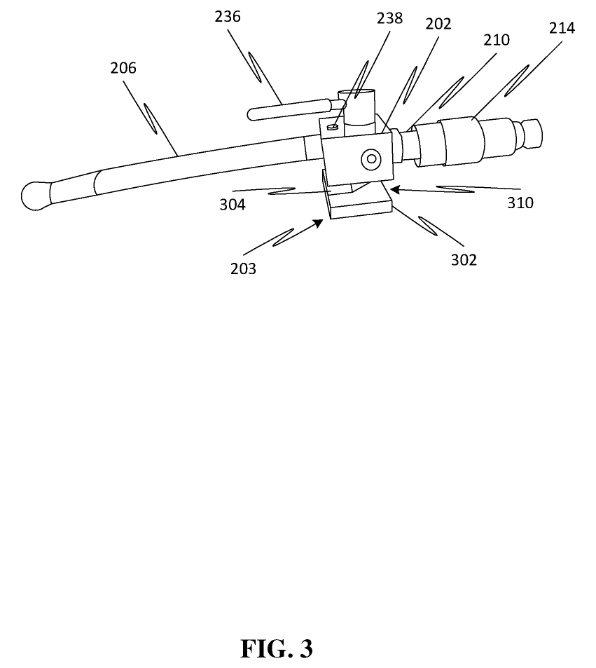

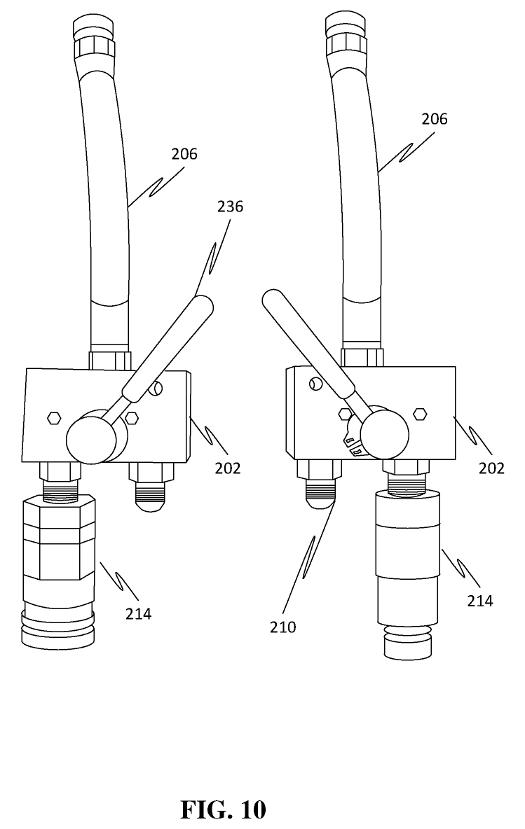

A quick coupler 210 (FIG. 3 and FIG. 10) is a hydraulic connection assembly configured to permit rapid connection and disconnection of fluid lines without tools. The quick coupler 210 typically includes a male plug and a female body having internal check valves that automatically close when disconnected to reduce fluid loss and contamination. A quick coupler, e.g., a flat-faced hydraulic quick coupler, for connecting an attachment to at least one of the second fluid port or the third fluid port of the diverter valve. Flat-faced couplers provide reduced fluid loss during connection and disconnection, improved contamination resistance, and reduced trapped pressure during coupling. This enhances ease of tool interchange.

A sliding collar 214 is a movable sleeve component of the quick coupler that shifts axially to engage or disengage a locking mechanism. Movement of the sliding collar 214 allows insertion or removal of the mating plug and secures the connection when released.

The diverter valve assembly 200 can include the JIC hose end fitting 212 to connect the second port 232 or third port 234 of the diverter valve 202 to the existing thumb hose 116 for the excavator thumb. The JIC (Joint Industry Council) hose end fitting 212 has a first end provided with an SAE O-ring for connecting to the third port 234 of the diverter valve 202. The JIC hose end fitting 212 further has a second end provided with a JIC cone which can be used to connect the thumb hose 116. The JIC cone may comprise a 37-degree flare surface configured to mate with a corresponding 37-degree flared seat of a complementary JIC fitting on the thumb hose 116. Upon tightening of the threaded coupling nut, the opposing flare surfaces are drawn into metal-to-metal sealing engagement to provide a fluid-tight hydraulic connection.

The flat-faced quick coupler 210 has a first end fitted with SAE O-ring for connecting to the second port 232 of the diverter valve 202, and a second end including an NPT (National Pipe Tapered) standard thread. The second end with the NPT thread can be used to attach the sliding collar 214. Existing thumb hose 116, disconnected from rigid auxiliary pipe 104, 106 and is reconnected to the port 232, 234 of diverter valve 202 via hose end fitting 212. This re-establishes hydraulic connection between diverter valve 202 and, e.g., the thumb.

As noted above, the retrofit kit including the diverter valve assembly 200 is an after-market system. To accommodate various OEM and various models of machines produced by an OEM, the retrofit kit may include various hoses 206. A user may select a hose 206 from multiple hydraulic hoses 206 included in the retrofit kit. A hose 206 length may be determined based on a machine 101 model. A hose 206 length may correspond to a mounting geometry of the machine 101 model based on dimensional information associated with the machine 101 model. For example, a length of the hose 206 may substantially (i.e., within a range of a few centimeters) match a length of a rigid pipe 104, 1-6 that is removed in a process of installing the hose 206.

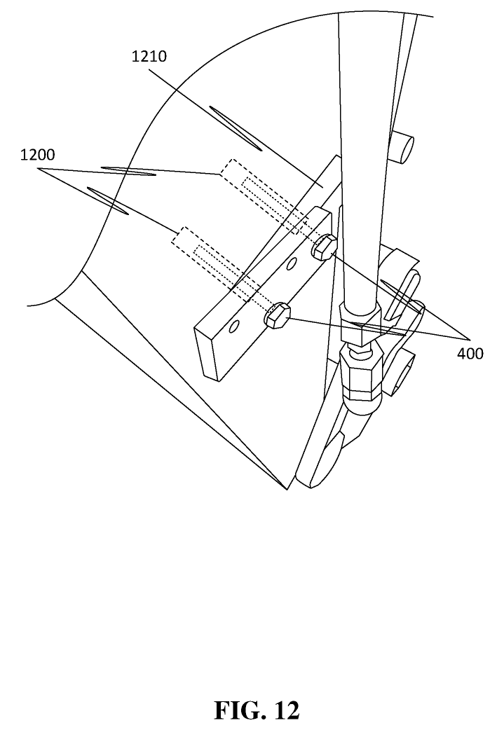

A reconfiguration of hydraulic plumbing 100 to install the retrofit kit further includes mechanical attachment of the diverter valve 202 to the machine 101. With reference to FIGS. 3-13, an attachment system 203 for attaching the diverter valve 202 to a machine 101 includes an adapter plate 302, a spacer bar 304, and mechanical coupling for securing the diverter valve 202, the spacer bar 304 and the adapter plate 302 to the machine 101. The adaptor plate 302 is configured to attach to pre-existing mounting holes 1200 (FIG. 12) on a structural member, e.g., a stick, of the machine 101 without drilling or welding.

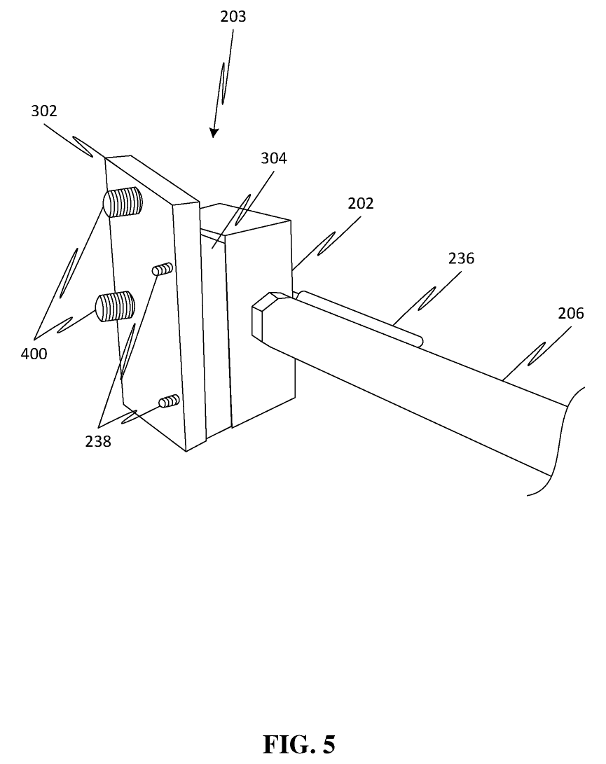

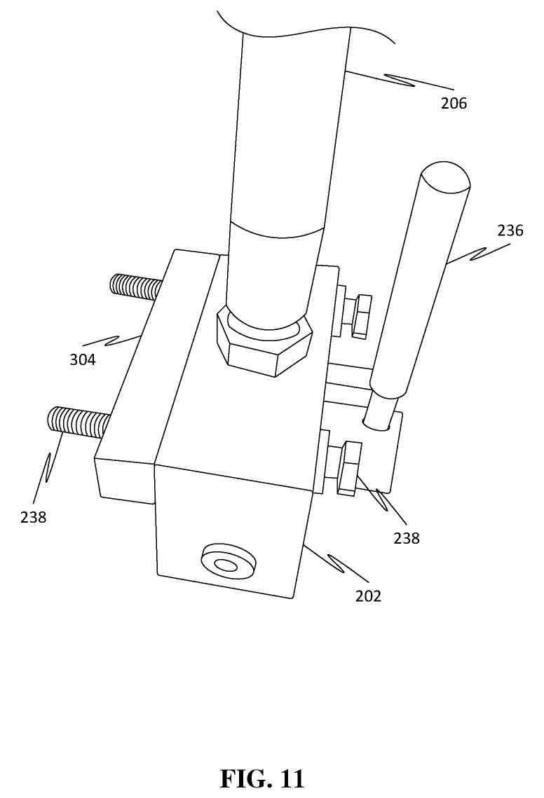

After the clamp 110 is removed, the adapter plate 302 is fastened to the stick 102 of the machine 101, e.g., excavator, using bolts 400 (FIGS. 4-5) with matching threads for the mounting holes 1200 (FIG. 11). The bolts 400 may be the same as OEM provided bolts 112 to attach the clamp 110. Alternatively, if the length of the pre-existing bolts 112 is not suitable considering the difference in thickness of the adaptor plate 302 compared to a thickness of the removed clamp 110 then the bolts 400 provided by the kit may be used which are supplied as part of the retrofit kit.

The adapter plate 302 utilizes OEM provided holes 1200 on the machine 101. The adapter plate 302 includes a set of holes 902 aligned with corresponding holes 802 in the space bar 304 and holes of the diverter valve 202 for attaching the diverter valve 202 to the adapter plate 302. The adapter plate 302 has a second set of holes 904 aligned with corresponding holes 1200 on the stand-off plate 1210 on the machine 101 for attaching the adapter plate 302 to the machine 101.

The spacer bar 304 forms holes 802 that are aligned with the holes on the diverter valve 202 and further aligned with the first set of holes 902 on the adapter plate 302, such that the diverter valve 202, the spacer bar 304 and the adapter plate 302 are mechanically attachable using a plurality of bolts 400.

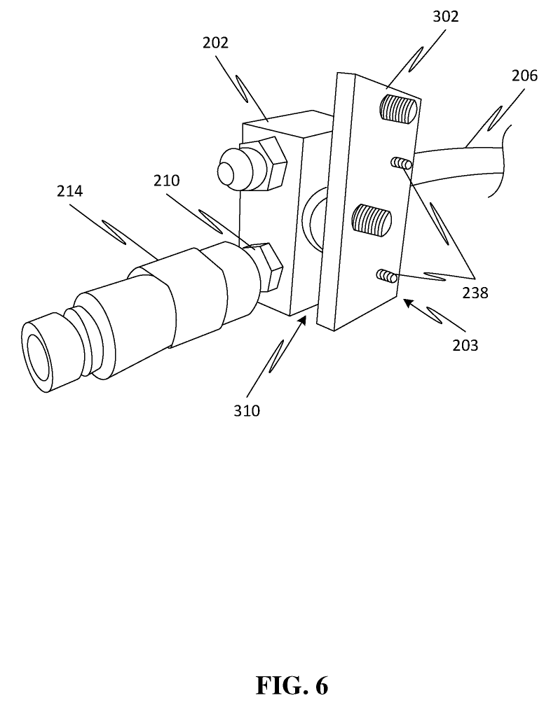

With reference to FIGS. 5-6, the spacer bar 304 is mountable between the diverter valve 202 and the adapter plate 302, such that when assembled a cavity 310 is formed between the diverter valve 202 and the adapter plate 302 while the diverter valve 202 remains in contact with the adapter plate 302 at one or more location.

Referring now to FIG. 3, the diverter valve assembly 200 includes the adapter plate 302 and the spacer bar 304. A first side of the adapter plate 302 is adapted to be connected to the machine 101, e.g., being bolted to the stand-off plate 1210 on the stick 102 of the excavator machine 101, and a second side to be directly connected to the spacer bar 304.

The spacer bar 304 has a first side and a second side. The spacer bar 304 is arranged between the adapter plate 302 and the diverter valve 202. Bolts 238 can be used to fasten the diverter valve 202, the space bar 304 and the adapter plate 302 together (see, for example, FIG. 5). As shown in FIG. 3, when the diverter valve assembly 200 is assembled, the adapter plate 302, spacer bar 304 and diverter valve 202 form a cavity 310. The cavity 310 provides space for the heads of bolts 400 that are used to attach the adapter plate 302 to the machine 101.

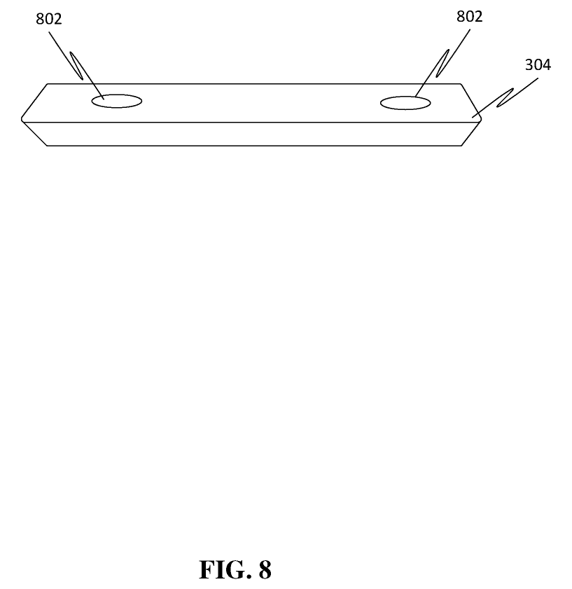

FIG. 8 illustrates an example spacer bar 304. The spacer bar 304 forms two holes 802. The two holes 802 are positioned on the space bar 304 to align with holes in the diverter valve 202 to allow the bolts 238 of the diverter valve to pass through the holes 802 to the adapter plate 302.

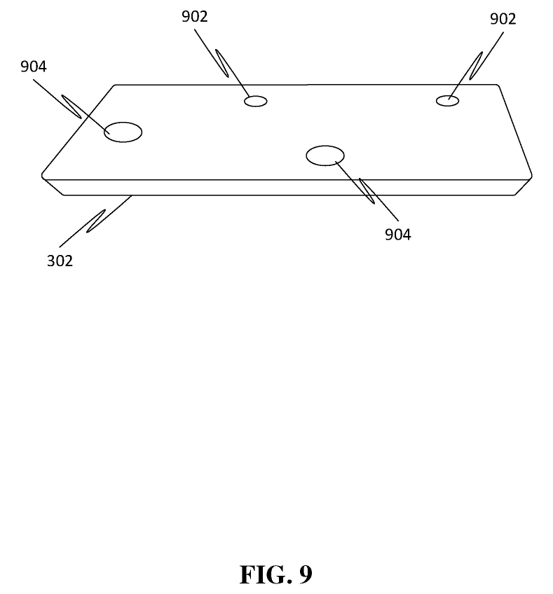

FIG. 9 illustrates an example adapter plate 302. The adapter plate 302 forms two holes arranged to align with the holes 802 on the spacer bar 304, such that the adapter plate 302, spacer bar 304 and the diverter valve 202 can be fastened together with the bolts 238. The adapter plate 302 forms two additional holes 904 that are arranged to facilitate attaching the adapter plate 302 to, e.g., the stick 102 of the excavator machine 101, via an additional set of bolts 238. The holes 904 are located on the adapter plate 302 such that they can be aligned with holes 1200 in the stand-off plate 1210 in the stick 102 after removal of the original clamp 108, 110 (FIG. 1).

Typically, the adapter plate 302 is designed for a specific model of a machine 101 to which the diverter valve assembly 200 is to be attached. Additionally, the adapter plate 302 may include multiple sets of mounting holes 904 corresponding to different machine 101 models. An adapter plate 302 may be configured for different machine 101 models having different mounting hole patterns. A pattern for a machine 101, in this context, means distance of holes 1200 on the machine relative to one another, size of holes 1200, type of threads of the holes 1200. Additionally or alternatively, multiple adapter plates 302 may be included in the retrofit including the diverter valve assembly 200. In this example, each of the included adapter plates 302 may include one or more set of holes 904 to accommodate one or more models of machines 101.

FIG. 10 shows two diverter valves 202 with hydraulic adapters such as quick coupler 210 and sliding collar 214 mounted to the valves 202. A diverter valve 202 may be installed on the pressure side and a second diverter valve 202 may be installed on the return side of the hydraulic system.

FIG. 11 illustrates a diverter valve 202 and a spacer bar 304 mechanically attached using a pair of bolts 238 via holes 802 of the spacer bar 304 that are aligned with the holes on the diverter valve 202.

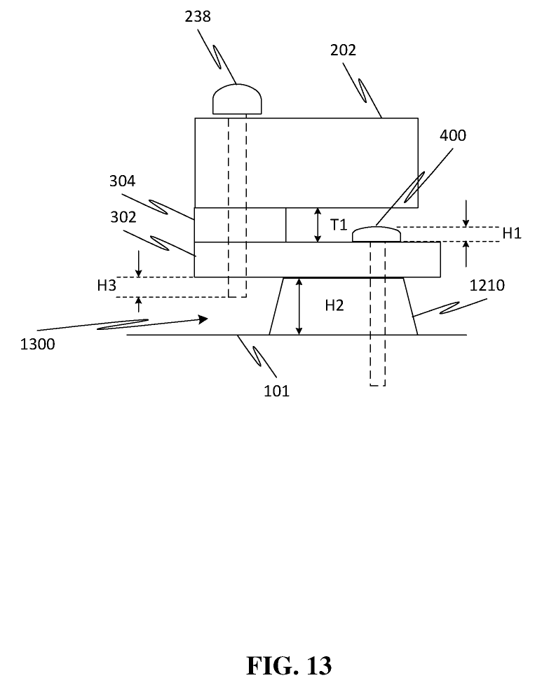

With references to FIGS. 12-13, the adapter plate 302 is mounted to the holes 1200 on the stand-off plate 1210 on the machine 101. A stand-off plate 1210 is a part of the machine 101, e.g., the stick, where the OEM has prepared for the attachment of the OEM supplied clamps 108, 110. The stand-off plate 1210 may be a piece of metal welded to the machine 101 including a number of holes 1200 to install the OEM clamps 108, 110.

After installation of the adapter plate 302, the stand-off plate 1210 is positioned between the adapter plate 302 and the structural member, e.g., the stick, of the machine 101. The stand-off plate 1210 can create a clearance gap 1300 between the adapter plate and the structural member, the clearance gap 1300 accommodating protruding fastening elements, e.g., the bolts 238 extending from the adapter plate 302 toward the structural member of the machine 101.

With reference to FIG. 13, a thickness T1 of the cavity 310 shall be greater than a height H1 of a head of the mechanical fastener, e.g., the bolt 400, protruding beyond the adapter late 302 into the cavity 310. Additionally, a height H2 of the stand-off plate 1210 protruding beyond a surface of the machine 101 member such as the stick, shall be greater than a height H3 of the part of the fastener, e.g., the bolt 238, protruding beyond the adapter plate 302 into the clearance gap 1300. In some examples, a machine 101 may lack a stand-off plate 1210 or a height H2 of the stand-off plate 1210 may be less than the height H3 of the bolt 238 penetrating the clearance gap 1300. In such an example, the retrofit kit may include a mechanical component such a washer that can be used to increase a height H2 of the clearance gap 1300 to accommodate the installation of the diverter valve assembly 200.

As noted above, a hydraulic system for an excavator includes a pressure side 115 and return side, each of which requires plumbing to manage the flow of hydraulic fluid. FIG. 15 shows an example hydraulic return side 1500 for the exemplary excavator machine 101 of FIG. 1. Accordingly, a hydraulic port expansion system can include two sets of the diverter valve assembly 200. Specifically, the retrofit kit will include two diverter valves 202, two hydraulic hoses 206, and two each of the NPT bulkhead adaptor 208, the flat-faced quick coupler 210, the JIC hose end fitting 212 and the sliding collar 214. The retrofit kit will further include two adapter plates 302 and two spacer bars 304. The retrofit kit further includes appropriate bolts 238 for attaching the diverter valve 202 together with the spacer bar 304 and adapter plate 302 and bolts 400 for attaching the adapter plate 302 to the machine 101. As noted above, in some cases, the original piping configuration for the pressure side and return side are the same. In these cases, the adapter plate 302 and space bar 304 can be the same for both sets of the diverter valve assembly 200 included in the hydraulic port expansion system. In other cases, two different adapter plates 302 and possibly two different spacer bars 304 may be necessary in the hydraulic port expansion system to accommodate the differences between the original pressure 115 and return side 1500 piping on a machine 101.

In some embodiments, a first diverter valve assembly 200 is mounted on a first lateral face of excavator stick 102 corresponding to a pressure hydraulic circuit, and a second diverter valve assembly 200 is mounted on an opposite lateral face corresponding to a return hydraulic circuit. In certain embodiments, the assemblies are geometrically mirrored relative to one another.

This dual-side configuration provides hydraulic and mechanical benefits. Installing assemblies on opposite lateral faces distributes added weight symmetrically about the stick centerline, minimizing asymmetric loading and reducing imbalance during articulation. Symmetrical installation also maintains similar hose routing length and bend geometry on both sides, promoting balanced hydraulic flow characteristics between pressure and return lines. Mirrored geometry further standardizes manufacturing and kit packaging, allowing use of common components across both sides while maintaining predictable mounting orientation.

In some examples, the pressure and return piping on a machine 101 are different. The retrofit kit can include different adapter plates 302 and possibly different space bars 304 for each of the two diverter valve assemblies 200 to accommodate the different configurations of the pressure and return sides.

The retrofit kit can be designed such that it can be adapted to various machines by exchanging only the adapter plate 302 or in some cases the adapter plate 302 and spacer bar 304, with the other components remaining the same.

Other arrangements are possible within the scope of the disclosure. For example, a retrofit kit according to the disclosure may have one adapter plate 302 for one diverter assembly 200, and a second adapter plate 302 of the second diverter assembly included in the hydraulic expansion system.

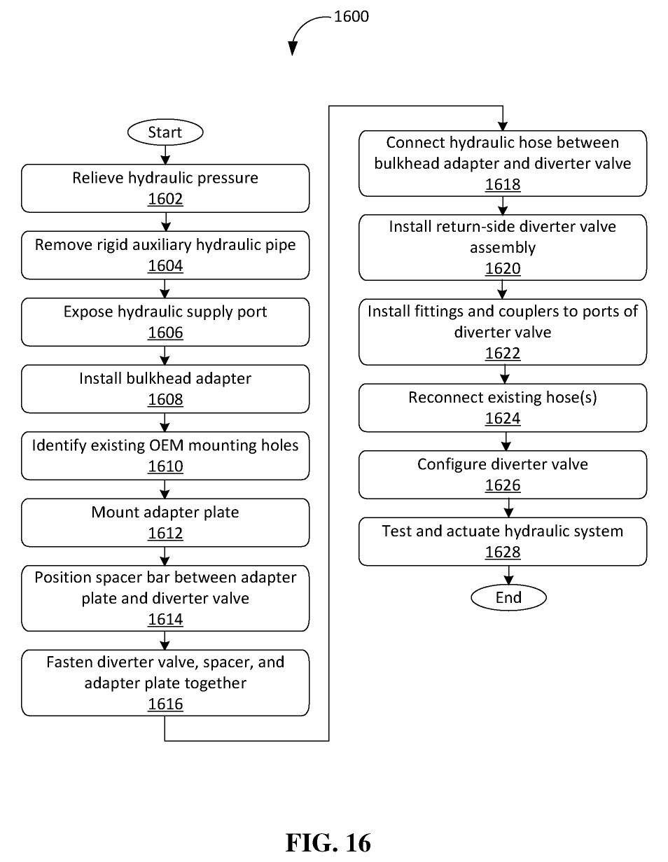

FIG. 16 is a flowchart of an example process 1600 to install the diverter valve assembly 200 on a machine 101 after being manufactured by an OEM.

In all embodiments of process 1600, installation of the diverter valve assembly 200 is performed without cutting, drilling, welding, boring, machining, deforming, or otherwise permanently altering any OEM hydraulic pipe, connector, structural member, or mounting hole of the machine 101. All connections are made using threaded interfaces, removable fasteners, and reversible fittings. No OEM hydraulic component is shortened, modified, or destroyed during installation. Accordingly, the removed rigid auxiliary pipe 104, 106 and associated clamps 108, 110 remain reusable and may be reinstalled to restore the machine 101 to its original OEM hydraulic configuration.

The process 1600 starts with a block 1602 in which a hydraulic system pressure of the machine 101 is relieved. The pressure may be relieved by turning the ignition off. The block 1602 may further include additional steps to ensure that residual pressure is fully relieved.

Next, in a block 1604, a rigid auxiliary pipe 104, 106 is removed. The removed rigid auxiliary pipe 104, 106 is preserved in its original form and is not cut, drilled, or otherwise modified, thereby permitting later reinstallation if desired.

Next, in a block 1606, a hydraulic supply port, e.g., at the connector bis exposed.

Next, in a block 1608 a bulkhead adapter 208 is installed. The fluid coupling performed in blocks 1608 and 1618 is accomplished without cutting, drilling, welding, or otherwise permanently modifying any existing auxiliary hydraulic pipe or circuit component of the machine 101, thereby preserving the ability to restore the machine to its original OEM hydraulic configuration. The bulkhead adapter 208 interfaces with existing threaded ports and sealing surfaces of the machine 101 without requiring enlargement, rethreading, or alteration of the OEM hydraulic supply port.

Next, in a block 1610, existing OEM mounting holes 1200 are identified. The holes 1200 may be on a stand-off plate 1210.

Next, in a block 1612 an adapter plate 302 is mounted to the machine 101. This step may further include identifying an adapter plate 302 among multiple provided adapter plates 302 by comparing the geometry of holes on the adapter plates 302 to the mounting holes 1200 available on the machine 101. In some examples, an adapter plate 302 may include multiple set of holes 904 provided for different models of machines 101. The selection of the adapter plate 302 may include determining a mounting hole 1200 pattern and spatial geometry of the structural member of the machine 101 and selecting an adapter plate 302 having a corresponding hole pattern, thereby enabling installation using only pre-existing mounting holes without drilling or welding. The adapter plate 302 is secured exclusively using pre-existing OEM mounting holes 1200 and removable fasteners, without creating new holes or altering the structural member of the machine. Selection of the adapter plate 302 may include measuring a spacing between mounting holes 1200, identifying thread type and diameter, and comparing those parameters to corresponding mounting hole patterns provided on available adapter plates 302 included in the retrofit kit.

Next, in a block 1614, a spacer bar 304 is positioned between an adapter plate 302 and a diverter valve 202.

Next in a block 1616, the diverter valve 202, spacer bar 304, and the adapter plate 302 are fastened together using the bolts 238.

Next, in a block 1618, the hydraulic hose 206 is connected between the bulkhead adapter 208 and the diverter valve port 230. Prior to connection, a hydraulic hose 206 may be selected from a plurality of hoses having different lengths based on dimensional information associated with the machine 101 model, such that the selected hose length corresponds to a mounting geometry of the machine.

Next, in a block 1620, a second diverter valve assembly 200 is installed on the return side 1500.

Next, in a block 1622, fittings and couplers to ports 232, 234 of the diverter valve 202 are installed.

Next in a block 1624, existing hoses, e.g., the hose 116, to hydraulic accessories are reconnected.

Next, in a block 1626, configure the diverter valves 202 positions to select a hydraulic accessory for use. This step may be performed manually, electrically, or electro-hydraulically actuating the diverter valves 202 to select a port 232, 234. This selection shall be performed to select a same accessory both on pressure side 115 and return side 1500, thereby ensuring the same accessory is activated on both pressure side 115 and the return side 1500. Coordinated actuation of the first diverter valve assembly on the pressure side and the second diverter valve assembly on the return side enables selective routing of hydraulic flow to three selectively operable auxiliary hydraulic ports derived from two original auxiliary hydraulic circuits.

Next, in a block 1628, a use may test and actuate the hydraulic system, e.g., using the thumb accessory. Following the block 1628, the process 1600 ends or returns to the block 1610.

What has been described above is an example of the present disclosure. It is, of course, not possible to describe every conceivable combination of components or methodologies for purposes of describing the present invention, but one of ordinary skill in the art will recognize that many further combinations and permutations of the present invention are possible. While certain novel features of this disclosure shown and described below are pointed out in the annexed claims, the disclosure is not intended to be limited to the details specified, since a person of ordinary skill in the relevant art will understand that various omissions, modifications, substitutions and changes in the forms and details of the disclosure illustrated and in its operation may be made without departing in any way from the spirit of the present disclosure. Accordingly, the present disclosure is intended to embrace all such alterations, modifications, and variations that fall within the scope of the appended claims. As used herein, the term "includes" means includes but not limited to, the term "including" means including but not limited to. The term "based on" means based at least in part on. Additionally, where the disclosure or claims recite "a," "an," "a first," or "another" element, or the equivalent thereof, it should be interpreted to include one or more than one such element, neither requiring nor excluding two or more such elements. No feature of the disclosure is critical or essential unless it is expressly stated as being “critical” or “essential.” The terms “attached,” “connected,” “coupled,” or similar terms are to be understood as directly (i.e., in direct contact with), or indirectly (via one or more intervening structures) connected. The terms “directly attached,” “directly connected,” “directly coupled,” mean that the objects are in direct contact with each other without any intervening structure.

1. A diverter valve assembly for a hydraulic system comprising:
a diverter valve that couples a first fluid port to either a second fluid port or a third fluid port depending on a position of the diverter valve; and
an attachment system for attaching the diverter valve to a machine; wherein the attachment system includes an adapter plate configured to attach to pre-existing mounting holes on a structural member of the machine including a stick without drilling or welding, wherein the diverter valve is mechanically secured to the adapter plate.

2. The diverter valve assembly according to claim 1, wherein the adapter plate includes a first set of holes aligned with corresponding holes in the diverter valve for attaching the diverter valve to the adapter plate, and a second set of holes aligned with corresponding holes on the machine for attaching the adapter plate to the machine.

3. The diverter valve assembly according to claim 2, wherein the attachment system further includes a spacer bar, wherein the spacer bar is mountable between the diverter valve and the adapter plate, such that when assembled a cavity is formed between the diverter valve and the adapter plate while the diverter valve remains in contact with the adapter plate at one or more locations.

4. The diverter valve assembly according to claim 3, wherein the spacer bar forms holes that are aligned with the holes on the diverter valve and further aligned with the first set of holes on the adapter plate, such that the diverter valve, the spacer bar and the adapter plate are mechanically attachable using a plurality of bolts.

5. The diverter valve assembly according to claim 1, further comprising a hydraulic hose selected from a plurality of hydraulic hoses, wherein the plurality of hydraulic hoses includes at least a first hose having a first length corresponding to a first machine model and a second hose having a second length corresponding to a second machine model.

6. The diverter valve assembly according to claim 5, further comprising a bulkhead adapter to connect a first end of one of the plurality of hydraulic hoses to an existing auxiliary hydraulic circuit of the machine, wherein the bulkhead adapter is configured to interface with a pre-existing auxiliary hydraulic pipe of the machine without permanently modifying a hydraulic circuit.

7. The diverter valve assembly according to claim 1, further comprising a quick coupler for connecting an attachment to at least one of the second fluid port or the third fluid port of the diverter valve.

8. The diverter valve assembly according to claim 1, wherein (i) the diverter valve assembly is configured for retrofit installation on an existing machine, (ii) the installation of the diverter valve assembly preserves operability of an original auxiliary hydraulic port, and (iii) the diverter valve assembly enables creation of an additional auxiliary hydraulic port.

9. The diverter valve assembly according to claim 1, wherein the adapter plate utilizes original equipment manufacturer mounting holes.

10. The diverter valve assembly according to claim 1, wherein the diverter valve assembly is provided as part of a retrofit kit comprising: a first diverter valve assembly fluidly connected to a pressure side of an auxiliary hydraulic circuit of the machine; and a second diverter valve assembly fluidly connected to a return side of the auxiliary hydraulic circuit of the machine, wherein selective actuation of the first diverter valve assembly and the second diverter valve assembly enables selective routing of hydraulic flow to three auxiliary hydraulic ports from two original auxiliary hydraulic circuits.

11. The diverter valve assembly according to claim 1, further comprising a stand-off plate positioned between the adapter plate and the structural member of the machine, the stand-off plate creating a clearance gap between the adapter plate and the structural member, the clearance gap accommodating protruding fastening elements extending from the adapter plate toward the structural member.

12. A retrofit kit for expanding auxiliary hydraulic functionality of a machine, comprising:
a diverter valve having a first fluid port selectively connectable to either a second fluid port or a third fluid port based on an position of the diverter valve;
an adapter plate configured to attach the diverter valve to pre-existing mounting holes on a structural member of the machine without drilling or welding;
at least one spacer bar configured to mount between the diverter valve and the adapter plate;
a bulkhead adapter configured to fluidly interface with an auxiliary hydraulic circuit of the machine; and
a plurality of hydraulic hoses having different lengths corresponding to different machine mounting geometries.

13. The retrofit kit according to claim 12, further comprising a second adapter plate configured for a second machine having a different mounting hole pattern.

14. The retrofit kit according to claim 12, wherein the adapter plate includes multiple sets of mounting holes corresponding to different machine models.

15. The retrofit kit according to claim 12, wherein the plurality of hydraulic hoses and the adapter plate are selected to enable installation on more than one machine model using only original equipment manufacturer mounting holes.

16. A method of expanding auxiliary hydraulic functionality of a machine, comprising:
mounting a diverter valve to a structural member of the machine using an adapter plate attached to pre-existing mounting holes on the structural member without drilling or welding;
fluidly coupling the diverter valve to an existing auxiliary hydraulic circuit of the machine; and
actuating the diverter valve to selectively route hydraulic flow from a first fluid port to either a second fluid port or a third fluid port.

17. The method according to claim 16, further comprising:
selecting at least one of a plurality of adapter plates having a mounting hole pattern corresponding to a machine model; and
a hydraulic hose having a length corresponding to a mounting geometry of the machine model, based on dimensional information associated with the machine model.

18. The method according to claim 16, wherein fluidly coupling the diverter valve to the existing auxiliary hydraulic circuit is performed without permanently modifying the existing auxiliary hydraulic circuit of the machine.

19. The method according to claim 16, further comprising:
mounting a second diverter valve to the structural member of the machine;
fluidly connecting a first diverter valve to a pressure side of the existing auxiliary hydraulic circuit and fluidly connecting the second diverter valve to a return side of the existing auxiliary hydraulic circuit; and
selectively actuating the first diverter valve and the second diverter valve to provide three selectively operable auxiliary hydraulic ports from two original auxiliary hydraulic circuits.

20. The diverter valve assembly according to claim 1, wherein the diverter valve is actuatable by (a) a manually actuated mechanism including at least one of a lever, a knob, a nut, or a tool-engageable drive member, (b) an electrical actuator, or (c) an electro-hydraulic actuator.
